(19) United States
(12) Patent Application Publication
(10) Pub. No.: US 2026/0331907 A1
(43) Pub. Date: Oct. 22, 2026

(54) TRANSIENT VOLTAGE SUPPRESSOR CIRCUIT WITH LOW CAPACITANCE

(71) Applicant: AMAZING MICROELECTRONIC CORP., New Taipei City (TW)

(72) Inventors: Sung-Chih Huang, Zhudong Township (TW); Chih-Ting YEH, Zhudong Township (TW); Chien-Ping CHEN, Taoyuan City (TW); Szu-Chia CHEN, Zhubei City (TW)

(73) Assignee: AMAZING MICROELECTRONIC CORP., New Taipei City (TW)

(21) Appl. No.: 19/182,103

(22) Filed: Apr. 17, 2025

(51) Int. Cl. H02H 9/04; H02H 9/00

(52) U.S. Cl. CPC H02H 9/04; H02H 9/005; H02H 9/044

(57) ABSTRACT

A transient voltage suppressor circuit with low capacitance is provided, which comprises at least a first control element, a first surge protection element and a first clamping element, wherein the first surge protection element is electrically connected in parallel with the first control element, and an anode and a cathode of the first surge protection element is respectively coupled to a second pin and a first pin. In addition, the first clamping element is serially connected with the first control element in parallel with the first surge protection element, having a first end coupled to the second pin and a second end coupled to a third pin. By employing the first surge protection element as a uni-directional device having a snapback property, the disclosed transient voltage suppressor circuit is characterized by having low capacitance and preventing the surge protection element from being damaged when an electrostatic discharge event occurs.

### BACKGROUND OF THE INVENTION

### Field of the Invention

The present disclosure is related to a transient voltage suppressor design scheme. And more particularly, the present invention is related to a transient voltage suppressor structure which is characterized by having low capacitance. The disclosed transient voltage suppressor circuit is proposed as not influenced by the conventional RC delay time when an electrostatic discharge (ESD) event occurs, thereby protecting the transient voltage suppressor from being damaged.

### Description of the Prior Art

As known, a transient voltage suppressor or known as a “VS” is a general classification of electronic components that are designed to react to sudden or momentary overvoltage conditions. One such common device used for this purpose is known as the transient voltage suppression diode, a Zener diode designed to protect electronics device against over-voltages. In general, the characteristic of a transient voltage suppressor (TVS) requires that it responds to over-voltages faster than other common overvoltage protection components such as varistors or gas discharge tubes. Such characteristic of the TVS device or component makes it much more useful for protection against extremely fast and often damaging voltage spikes, since these fast overvoltage spikes are present on all distribution networks and can be caused by either internal or external events, such as lightning or motor arcing. In addition, applications of the transient voltage suppression devices are able to be used for unidirectional or bidirectional electrostatic discharge (ESD) protection of transmission or data lines in electronic circuits. Usually, the level of the ESD energy in a transient overvoltage can be equated to energy measured in joules or related to electric current when devices are rated for various applications. These bursts of overvoltage can be measured with specialized electronic meters that can show power disturbances of thousands of volts amplitude that last for a few microseconds or less.

An U.S. patent number of U.S. Pat. No. 10,978,441 B2 has disclosed a transient voltage suppressor and a method for manufacturing the same, wherein according to the disclosed prior transient voltage suppressor, an additional gate stack layer is introduced based on the prior transient voltage suppressor, and the diffusion isolation regions are reused as the conductive vias, so that, the gate stack layer, the first doped region, the conductive vias, and the second semiconductor layer constitute a MOS transistor being coupled in parallel to the Zener diode or the avalanche diode of the transient voltage suppressor. According to the prior art as disclosed in the U.S. Pat. No. 10,978,441 B2, when the current of the I/O terminal is relatively large, the MOS transistor is turned on to share part of the current of the I/O terminal through the Zener diode or the avalanche diode, thereby protecting the Zener diode or the avalanche diode from being damaged due to excessive current. The main purpose of the disclosed U.S. patent number of U.S. Pat. No. 10,978,441 B2 is to enhance the robustness of the transient voltage suppressor without increasing its manufacture cost.

Please refer to FIG. 1, which generally shows a schematic diagram of a conventional equivalent circuit diagram of a prior transient voltage suppressor device as disclosed in the U.S. patent number of U.S. Pat. No. 10,978,441 B2. And FIG. 2 is its capacitance equivalent circuit diagram according to the circuit diagram in FIG. 1. As can be seen in FIG. 1, the Zener diode DZ is coupled to a first rectifier diode DC1 in series and then coupled to a second rectifier diode DC2 in parallel between the input and output (I/O) terminal I/O and the ground terminal GND. When a positive electrostatic discharge voltage occurs at the input and output terminal I/O, an electrostatic current flows from the first rectifier diode DC1, the Zener diode DZ to the ground terminal GND, the first rectifier diode DC1 is forward biased, the Zener diode DZ is broken down reversely, so that a voltage of the input and output terminal I/O is clamped at a relatively small value. On the other hand, when a negative electrostatic discharge voltage occurs at the input and output terminal I/O, the electrostatic current flows through the second rectifier diode DC2 from the ground terminal GND to the input and output (I/O) terminal I/O and the first rectifier diode DC1 is reversely biased. Please also refer to the capacitance equivalent circuit as illustrated in FIG. 2, that the I/O-to-ground capacitance C_{I/O-GND} between the input and output terminal I/O and the ground terminal GND will be equal to [C1*CZ/(C1+CZ)]+C2, wherein C1 is the capacitance of the first rectifier diode DC1, C2 is the capacitance of the second rectifier diode DC2, and CZ is the capacitance of the Zener diode DZ. Due to the Zener diode DZ serving as an ESD protection device, in order to realize a strong ESD protection, the Zener diode DZ in the prior art has to be designed to have a relatively large PN junction area, resulting that the capacitance of the Zener diode DZ, which is the capacitance CZ, will be inevitably large, and the I/O-to-ground capacitance C_{I/O-GND} can be approximately equal to (C1+C2). Thus, a prior transient voltage suppressor, in order to decrease its parasitic capacitance, can only reduce C1 (the capacitance of the first rectifier diode DC1) and C2 (the capacitance of the second rectifier diode DC2) as much as possible. What also draws our attention is that, when a positive surged operating mode is applied to such a conventional transient voltage suppressor structure, the conducting path constructed by the Zener diode DZ in series with the first rectifier diode DC1 should be turned on first. However, in practical, since there exists resistance in the metal line of the circuit or even in the wiring bonding in addition to certain parasitic capacitance of these components themselves, the accordingly generated RC delay time is always inevitably found and observed. Due to such realistic and practical factors, when the conducting path constructed by the Zener diode DZ in series with the first rectifier diode DC1 is not able to conduct in time, such that the junction breakdown of the second rectifier diode DC2 occurs first, it causes that the second rectifier diode DC2 will be severely damaged. And such phenomena are certainly unfavorable and not expected in the industrials and also in the technical fields.

As a result, based on the foregoing drawbacks and necessary suppression and elimination of the conventional issues are thus to be expected, it, in view of all, should be apparent and obvious that there is indeed an urgent need for the professionals in the field for a novel and inventive transient voltage suppressor device structure to be developed, so as to solve the above-mentioned issues occurring in the prior arts. And in particular, the full detailed specific descriptions and implementations of how to implement an effective transient voltage suppressor device structure, especially having low capacitance, will be now to be provided by the Applicants of the present invention in the following paragraphs as below for your references.

### SUMMARY OF THE INVENTION

In order to overcome the above-mentioned disadvantages, one major objective in accordance with the present invention is provided for a novel and creative circuit scheme for providing a transient voltage suppressor circuit. And more particularly, the proposed circuit scheme of the disclosed transient voltage suppressor circuit is characterized by having relatively low capacitance and preventing the device from being damaged under an electrostatic discharge (ESD) event.

Another objective in accordance with the present invention is to provide a novel and inventive transient voltage suppressor circuit with low capacitance, in which a uni-directional device having a snapback property is employed as a surge protection element of the disclosed transient voltage suppressor circuit, and the uni-directional device having a snapback property, for example, can be a bipolar junction transistor (BJT) or a silicon controlled rectifier (SCR). The proposed uni-directional device having a snapback property, which is configured in the disclosed transient voltage suppressor circuit, can be well designed to have low capacitance. In addition, a significantly higher electrostatic discharge (ESD) robustness of the disclosed transient voltage suppressor circuit can be achieved by employing the uni-directional device having a snapback property as the surge protection element thereof.

And yet, one more another objective in accordance with the present invention is to provide an inventive and new transient voltage suppressor circuit with low capacitance, in which when the electrostatic discharge event is taking place, the disclosed transient voltage suppressor circuit can be independent and not affected by the accordingly RC delay time generated in the circuit. As a result, it is believed that the previously described shortcomings existing in the prior arts can be effectively avoided and solved, thereby protecting the surge protection element disposed in the disclosed transient voltage suppressor circuit from being damaged.

In addition, a plurality of the surge protection elements can be further disposed in series in the disclosed transient voltage suppressor circuit. Alternatively, a plurality of diodes which are connected in series with the surge protection element may be employed as well in order to further reduce the capacitance of the disclosed transient voltage suppressor circuit since the surge protection element has been disposed to withstand most of the electrostatic discharge energy so that the diodes connected thereafter can be under well protection.

Therefore, in the following descriptions, the Applicants will proceed to provide a plurality of embodiments and variations that will be discussed later in the following paragraphs in order to verify the proposed transient voltage suppressor circuit with low capacitance is effective. Thereby, it is worthy of full attentions that the present invention achieves to successfully solve the problems of prior arts and meanwhile maintain superior electrical properties. As a result, it is believed that the proposed technical contents of the present invention are extremely advantageous of as being highly competitive and able to be widely utilized in related IC and semiconductor industries.

Therefore, in order to achieve the above-mentioned objectives, the present invention is aimed to provide a modified and improved transient voltage suppressor circuit with low capacitance, and the proposed transient voltage suppressor circuit with low capacitance will now be introduced as in the following descriptions.

According to one embodiment of the present invention, the disclosed transient voltage suppressor circuit with low capacitance comprises at least a first control element, a first surge protection element and a first clamping element, wherein an anode of the first control element is electrically coupled to a first pin, and a cathode of the first control element is electrically coupled to a second pin.

The first surge protection element, which is electrically connected in parallel with the first control element, has an anode electrically coupled to the second pin. On the other hand, a cathode of the first surge protection element is electrically coupled to the first pin.

In addition, the first clamping element, which is serially connected with the first control element in parallel with the first surge protection element is further disposed, wherein the first clamping element has a first end coupled to the second pin and a second end coupled to a third pin.

In one embodiment, the first control element, for instance, can be selected from a group consisting of a diode, a bipolar junction transistor (BJT) and a silicon controlled rectifier (SCR). And the first clamping element can be selected from a group consisting of a Zener diode, a bipolar junction transistor (BJT), a metal oxide semiconductor field effect transistor (MOSFET), and a silicon controlled rectifier (SCR). What is characterized by the present invention is that, the first surge protection element is a uni-directional device having a snapback property. For instance, the first surge protection element is an element selected from a group consisting of a bipolar junction transistor (BJT) and a silicon controlled rectifier (SCR).

According to another feasible embodiment of the present invention, the disposed transient voltage suppressor circuit with low capacitance may further comprise a second control element and a second surge protection element, wherein an anode of the second control element is electrically coupled to a fourth pin, and a cathode of the second control element is electrically coupled to the third pin. Meanwhile, the second surge protection element is electrically connected in parallel with the second control element, and an anode of the second surge protection element is electrically coupled to the third pin, and a cathode of the second surge protection element is electrically coupled to the fourth pin.

In such a variant embodiment of the present invention, the disclosed second surge protection element is a uni-directional device having a snapback property as well. For instance, the second surge protection element can be also selected from a group consisting of a bipolar junction transistor (BJT) and a silicon controlled rectifier (SCR). In addition, the second control element can be a diode, or the second control element can be the same element as the second surge protection element, which is a bipolar junction transistor (BJT) or a silicon controlled rectifier (SCR).

And moreover, according to one another feasible embodiment of the present invention, the disposed transient voltage suppressor circuit with low capacitance may further comprise a second clamping element, which is serially connected with the first control element in parallel with the first surge protection element. According to the embodiment, the second clamping element has a third end which is coupled to the first pin and the second clamping element has a fourth end which is opposite to the third end. The fourth end is, on the other hand, being electrically coupled to a fourth pin.

In such a variant embodiment of the present invention, the disclosed second clamping element can be selected from a group consisting of a Zener diode, a bipolar junction transistor (BJT), a metal oxide semiconductor field effect transistor (MOSFET), and a silicon controlled rectifier (SCR) as well.

In addition, according to one yet another feasible embodiment of the present invention, the disposed transient voltage suppressor circuit with low capacitance may further comprise a third control element which is electrically connected between the second pin and the first surge protection element, and the third control element is electrically connected in series with the first surge protection element. In one embodiment, the third control element for example, can be a diode and an anode of the third control element is electrically coupled to the second pin, and a cathode of the third control element is electrically coupled to the anode of the first surge protection element. In order to improve the electrostatic discharge (ESD) robustness of the disclosed transient voltage suppressor circuit, a plurality of the third control elements can be further connected in cascade between the first end of the first clamping element and the anode of the first surge protection element.

Moreover, in addition to the third control element, a fourth control element, a second surge protection element and a fifth control element can be further disposed according to one another feasible embodiment of the present invention. In details, the third control element is electrically connected between the second pin and the first surge protection element, and the third control element is electrically connected in series with the first surge protection element. The fourth control element is electrically coupled to and between a fourth pin as well as the third pin. The fifth control element is electrically connected between the third pin and the second surge protection element, and the fifth control element is further electrically connected in series with the second surge protection element. By such circuit configuration, the second surge protection element has one end which is electrically connected with the fifth control element, while the second surge protection element has another end which is opposite to the end connected with the fifth control element, and the another end is electrically connected to the fourth pin.

As can be seen, according to such a modified embodiment of the present invention, a plurality of the third control elements which are connected in series, or a plurality of the fifth control elements which are connected in series may be alternatively configured if necessary, so as to enhance the electrostatic discharge (ESD) robustness of the disclosed transient voltage suppressor circuit. Regarding the detailed circuit configurations, it is indicated that the plurality of the third control elements are connected in cascade between the first end of the first clamping element and the anode of the first surge protection element. And, on the other hand, the plurality of the fifth control elements are connected in cascade between the second end of the first clamping element and the anode of the second surge protection element. In addition, the cathode of the second surge protection element is further electrically connected to the fourth pin.

The first control element, the third control element, the fourth control element and the fifth control element can be alternatively selected from a group consisting of a diode, a bipolar junction transistor (BJT) and a silicon controlled rectifier (SCR).

And yet, another practicable embodiment of the present invention is proposed as if a third control element and a second clamping element are further configured at the same time in the transient voltage suppressor circuit. In specific, the second clamping element has a third end coupled to the first pin and a fourth end coupled to a fourth pin. The third control element is electrically connected between the second pin and the first surge protection element, and the third control element is electrically connected in series with the first surge protection element.

According to the embodiment of the present invention, the first clamping element and the second clamping element can be chosen and selected from a group consisting of a Zener diode, a bipolar junction transistor (BJT), a metal oxide semiconductor field effect transistor (MOSFET), and a silicon controlled rectifier (SCR). And the breakdown voltages of the first clamping element and the second clamping element can be fined tuned based on the maximum reverse working voltage V_{rwm} at the input and output (I/O) terminal of the disclosed transient voltage suppressor circuit with low capacitance.

Among the technical contents of the present invention, the first clamping element and the second clamping elements can be alternatively uni-directional devices or bi-directional devices. The present invention is not limited thereto.

To sum up, it is worthy of emphasizing that, the plurality of various disclosed configurations of the present invention are compatible with each other. In other words, people who are skilled in the art and having ordinary understandings and technical backgrounds to the present invention, are able to make various modifications or layout distributions depending on different circuit regulations and/or specifications without departing from the scope of the invention. That is to say, the present invention is certainly not limited thereto the disclosed embodiments. And the modified embodiments and/or circuit implementations if there is any, should still fall into the claim scope of the present invention.

In general, those skilled in the art and having general knowledge are able to make appropriate modifications or variations with respective to the technical contents disclosed in the present invention without departing from the spirits of the present invention. The present invention is not restricted by the certain limited configurations and/or circuit diagrams disclosed in the embodiments of the present invention. As such, it is believed that the modifications or variations should still fall into the scope of the present invention, and the present invention covers the modifications and its equality.

As a result, based on the disclosed technical features illustrated as above, it is evident that the present invention is sophisticatedly designed and indeed discloses a novel modified scheme for a new transient voltage suppressor circuit structure to be developed having a relatively capacitance. By adopting the present invention, it is believed that the present invention achieves in effectively eliminating the conventional drawback issues occurring in the prior arts. In addition, the electrostatic discharge (ESD) efficiency of the disclosed transient voltage suppressor circuit is greatly improved. And therefore, as a result, it is believed that the proposed transient voltage suppressor circuit with low capacitance as disclosed by the present invention, is beneficial in view of a great number of merits. Thus, it is believed that the present invention is extremely advantageous while compared to the prior arts.

These and other objectives of the present invention will become obvious to those of ordinary skill in the art after reading the following detailed description of preferred embodiments. And it is to be understood that both the foregoing general description and the following detailed description are exemplary and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings:

FIG. 1 generally shows a schematic diagram of a conventional equivalent circuit diagram of a prior transient voltage suppressor device as disclosed in the prior art.

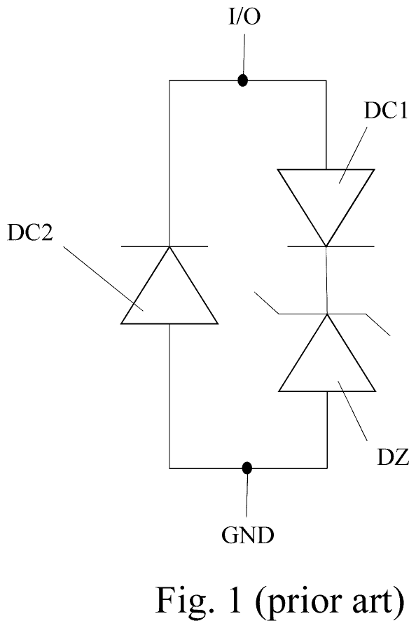

FIG. 2 schematically shows a capacitance equivalent circuit diagram according to the circuit diagram in FIG. 1.

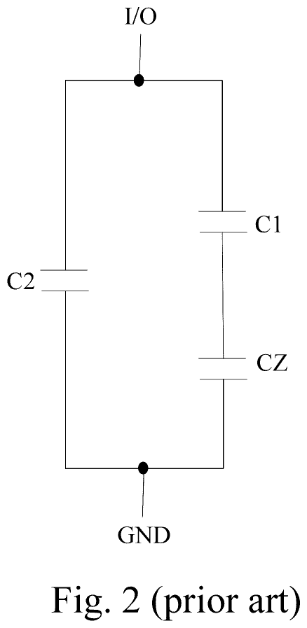

FIG. 3 schematically shows a circuit layout structural diagram of a proposed transient voltage suppressor circuit with low capacitance in accordance with a first embodiment of the present invention.

FIG. 4 schematically shows a circuit layout structural diagram of the proposed transient voltage suppressor circuit with low capacitance according to FIG. 3 when the first clamping element is a bi-directional device while the first pin is electrically connected with an input and output terminal and the third pin is electrically connected to a ground terminal.

FIG. 5 schematically shows another circuit layout structural diagram of the proposed transient voltage suppressor circuit with low capacitance according to FIG. 4 when the first control element can be adopted by using the same element as the first surge protection element.

FIG. 6 schematically shows a circuit layout structural diagram of the proposed transient voltage suppressor circuit with low capacitance according to FIG. 3 when the first clamping element is a bi-directional device while the third pin is electrically connected with an input and output terminal and the first pin is electrically connected to a ground terminal.

FIG. 7 schematically shows another circuit layout structural diagram of the proposed transient voltage suppressor circuit with low capacitance on the basis of FIG. 4 when a plurality of first surge protection elements are further disposed in the transient voltage suppressor circuit.

FIG. 8 schematically shows another circuit layout structural diagram of the proposed transient voltage suppressor circuit with low capacitance on the basis of FIG. 6 when a plurality of first surge protection elements are further disposed in the transient voltage suppressor circuit.

FIG. 9 schematically shows a circuit layout structural diagram of a proposed transient voltage suppressor circuit with low capacitance in accordance with one another embodiment of the present invention, which further includes a second control element and a second surge protection element.

FIG. 10 schematically shows another circuit layout structural diagram of a proposed transient voltage suppressor circuit with low capacitance in accordance with one yet another embodiment of the present invention, which further includes a second clamping element.

FIG. 11 schematically shows a circuit layout structural diagram of the proposed transient voltage suppressor circuit with low capacitance on the basis of FIG. 4 when the first clamping element is a uni-directional device.

FIG. 12 schematically shows a circuit layout structural diagram of the proposed transient voltage suppressor circuit with low capacitance on the basis of FIG. 6 when the first clamping element is a uni-directional device.

FIG. 13 schematically shows a circuit layout structural diagram of the proposed transient voltage suppressor circuit with low capacitance on the basis of FIG. 9 when the first clamping element is a uni-directional device.

FIG. 14 schematically shows a circuit layout structural diagram of the proposed transient voltage suppressor circuit with low capacitance on the basis of FIG. 10 when the first clamping element is a uni-directional device.

FIG. 15 schematically shows a circuit layout structural diagram of the proposed transient voltage suppressor circuit with low capacitance on the basis of FIG. 11 when a third control element is further configured in series with the first surge protection element.

FIG. 16 schematically shows a circuit layout structural diagram of the proposed transient voltage suppressor circuit with low capacitance on the basis of FIG. 15, which further comprises a plurality of the third control elements connected in series with the first surge protection element.

FIG. 17 schematically shows a circuit layout structural diagram of the proposed transient voltage suppressor circuit with low capacitance on the basis of FIG. 15, wherein the first clamping element can be alternatively a bi-directional device.

FIG. 18 schematically shows a circuit layout structural diagram of the proposed transient voltage suppressor circuit with low capacitance on the basis of FIG. 12 when a third control element is further configured in series with the first surge protection element.

FIG. 19 schematically shows a circuit layout structural diagram of the proposed transient voltage suppressor circuit with low capacitance on the basis of FIG. 18, which further comprises a plurality of the third control elements connected in series with the first surge protection element.

FIG. 20 schematically shows a circuit layout structural diagram of the proposed transient voltage suppressor circuit with low capacitance on the basis of FIG. 18, wherein the first clamping element can be alternatively a bi-directional device.

FIG. 21 schematically shows a circuit layout structural diagram of a proposed transient voltage suppressor circuit with low capacitance in accordance with a modified circuit structure on a basis of the transient voltage suppressor circuit of the previously disclosed embodiment in FIG. 11, which further comprises a third control element, a fourth control element, a second surge protection element and a fifth control element.

FIG. 22 schematically shows a circuit layout structural diagram of the proposed transient voltage suppressor circuit with low capacitance on the basis of FIG. 21, wherein the first clamping element can be alternatively a bi-directional device.

FIG. 23 schematically shows a circuit layout structural diagram of the proposed transient voltage suppressor circuit with low capacitance on the basis of FIG. 21, wherein a plurality of the third control elements are further configured and connected in series with the first surge protection element to enhance the ESD robustness.

FIG. 24 schematically shows a circuit layout structural diagram of the proposed transient voltage suppressor circuit with low capacitance on the basis of FIG. 21, wherein a plurality of the fifth control elements are further configured and connected in series with the second surge protection element to enhance the ESD robustness.

FIG. 25 schematically shows a circuit layout structural diagram of a proposed transient voltage suppressor circuit with low capacitance in accordance with a modified circuit structure on a basis of the transient voltage suppressor circuit of the previously disclosed embodiment in FIG. 11, which further comprises a third control element and a second clamping element.

FIG. 26 schematically shows a circuit layout structural diagram of the proposed transient voltage suppressor circuit with low capacitance on the basis of FIG. 25, wherein the first clamping element and the second clamping element can be alternatively bi-directional devices.

FIG. 27 schematically shows another circuit layout structural diagram of the proposed transient voltage suppressor circuit with low capacitance according to FIG. 15 when the first control element can be adopted by using the same element as the first surge protection element.

FIG. 28 schematically shows another circuit layout structural diagram of the proposed transient voltage suppressor circuit with low capacitance according to FIG. 18 when the first control element can be adopted by using the same element as the first surge protection element.

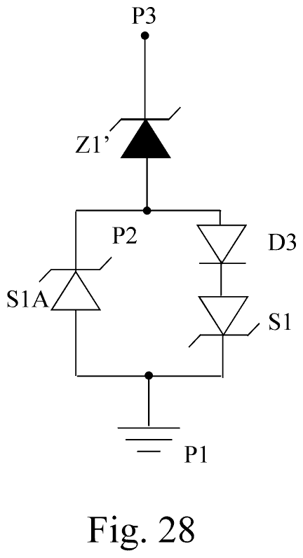

FIG. 29 schematically shows another circuit layout structural diagram of the proposed transient voltage suppressor circuit with low capacitance according to FIG. 21 when the first control element can be adopted by using the same element as the first surge protection element, and the fourth control element can be adopted by using the same element as the second surge protection element.

FIG. 30 schematically shows another circuit layout structural diagram of the proposed transient voltage suppressor circuit with low capacitance according to FIG. 25 when the first control element can be adopted by using the same element as the first surge protection element.

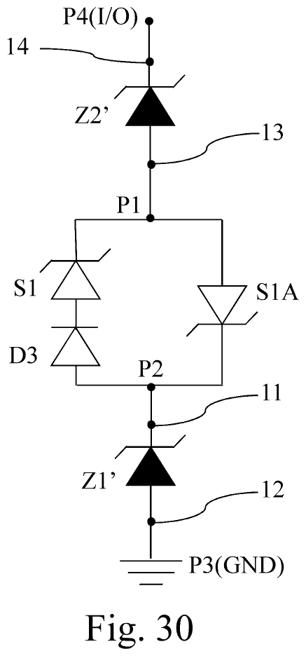

FIG. 31 schematically shows another circuit layout structural diagram of the proposed transient voltage suppressor circuit with low capacitance according to FIG. 17 when the first control element can be adopted by using the same element as the first surge protection element.

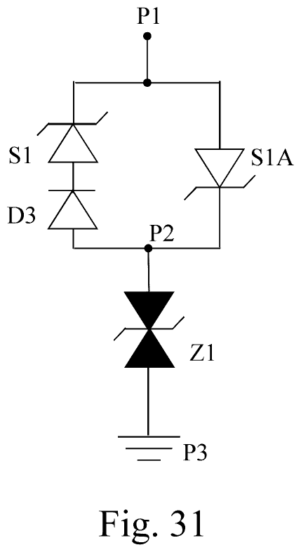

FIG. 32 schematically shows another circuit layout structural diagram of the proposed transient voltage suppressor circuit with low capacitance according to FIG. 20 when the first control element can be adopted by using the same element as the first surge protection element.

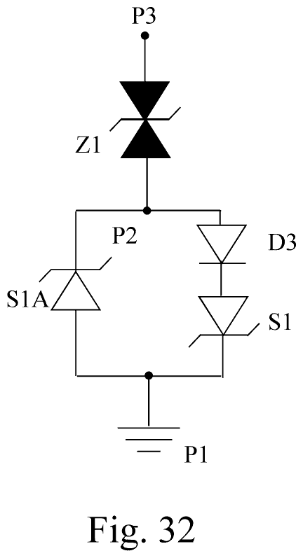

FIG. 33 schematically shows another circuit layout structural diagram of the proposed transient voltage suppressor circuit with low capacitance according to FIG. 22 when the first control element can be adopted by using the same element as the first surge protection element, and the fourth control element can be adopted by using the same element as the second surge protection element.

FIG. 34 schematically shows another circuit layout structural diagram of the proposed transient voltage suppressor circuit with low capacitance according to FIG. 26 when the first control element can be adopted by using the same element as the first surge protection element.

FIG. 35 schematically shows a layout structural diagram of a proposed transient voltage suppressor circuit with low capacitance in accordance with a first applicable embodiment of the present invention when the first surge protection element is implemented as a uni-directional P-type bipolar junction transistor device.

FIG. 36 schematically shows a layout structural diagram of a proposed transient voltage suppressor circuit with low capacitance in accordance with a second applicable embodiment of the present invention when the first surge protection element is implemented as a p-n-p-n silicon controlled rectifier device.

FIG. 37 schematically shows a layout structural diagram of a proposed transient voltage suppressor circuit with low capacitance in accordance with a third applicable embodiment of the present invention when the first surge protection element is implemented as a uni-directional N-type bipolar junction transistor device.

FIG. 38 schematically shows a layout structural diagram of a proposed transient voltage suppressor circuit with low capacitance in accordance with a fourth applicable embodiment of the present invention when the first surge protection element is implemented as a p-n-p-n silicon controlled rectifier device.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

The embodiments described below are illustrated to demonstrate the technical contents and characteristics of the present invention and to enable the persons skilled in the art to understand, make, and use the present invention. However, it shall be noticed that it is not intended to limit the scope of the present invention. Therefore, any equivalent modification or variation according to the spirit of the present invention is to be also included within the scope of the present invention.

Unless otherwise specified, some conditional sentences or words, such as “can”, “could”, “might”, or “may”, usually attempt to express that the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the article “a” and “the” includes the meaning of “one or at least one” of the element or component. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. Every example in the present specification cannot limit the claimed scope of the invention.

The terms “substantially,” “around,” “about” and “approximately” can refer to within 20% of a given value or range, and preferably within 10%. Besides, the quantities provided herein can be approximate ones and can be described with the aforementioned terms if are without being specified. When a quantity, density, or other parameters includes a specified range, preferable range or listed ideal values, their values can be viewed as any number within the given range.

As the Applicants have described earlier in the Description of the Prior Art, due to the practical RC delay time issue existing in the conventional transient voltage suppressor (TVS) devices, when a conducting path constructed by a Zener diode in series with a first rectifier diode is not able to conduct in time before a second rectifier diode which is in parallel with the expected conducting path, such that the junction breakdown of the second rectifier diode occurs first, it causes that the second rectifier diode will be damaged dramatically. And such effects definitely lead to unfavorable mass production. As a result, the Applicants of the present invention are aimed to solve such drawbacks and to provide a novel and inventive transient voltage suppressor circuit diagram. By disclosing and proposing the novel and modified transient voltage suppressor circuit diagram, the proposed transient voltage suppressor circuit is characterized by having low capacitance. In addition, the layout complexity of such transient voltage suppressor circuit is relatively low, without significant increasement in layout complexity while compared with the prior arts. In the following paragraphs, the disclosed transient voltage suppressor circuit with low capacitance will now be provided and illustrated by a plurality of variant embodiments as described in the following sections for your references.

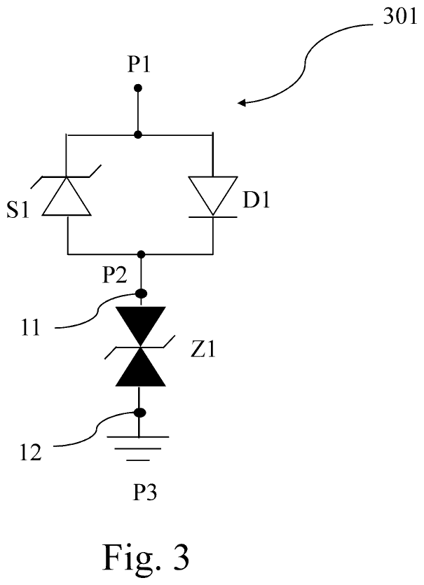

In the beginning, please refer to FIG. 3, which schematically shows a circuit layout structural diagram of a proposed transient voltage suppressor circuit with low capacitance in accordance with a first embodiment of the present invention. According to the first embodiment of present invention, the proposed transient voltage suppressor circuit with low capacitance 301 includes a first control element D1, a first surge protection element S1 and a first clamping element Z1, wherein an anode of the first control element D1 is electrically coupled to a first pin P1, and a cathode of the first control element D1 is electrically coupled to a second pin P2. The first surge protection element S1 is electrically connected in parallel with the first control element D1, and an anode of the first surge protection element S1 is electrically coupled to the second pin P2 while a cathode of the first surge protection element S1 is electrically coupled to the first pin P1. The first clamping element Z1 is further configured in the proposed transient voltage suppressor circuit and the first clamping element Z1 is serially connected with the above mentioned first control element D1 in parallel with the first surge protection element S1. As can be seen in the embodiment of FIG. 3, the first clamping element Z1 has a first end 11 which is coupled to the second pin P2 and a second end 12 which is coupled to a third pin P3.

According to the embodiment of the present invention, the first surge protection element S1 is a uni-directional device having a snapback property. As known, snapback is generally referred to a mechanism in a transistor in which avalanche breakdown or impact ionization provides a sufficient current to turn on the transistor. For instance, according to the embodiment of the present invention, the first surge protection element S1 can be selected from a group consisting of a bipolar junction transistor (BJT) and a silicon controlled rectifier (SCR). In one embodiment, when the first surge protection element S1 is determined as a bipolar junction transistor, the snapback is initiated by a small current from a collector of the bipolar junction transistor to its base. In the case of ESD protection devices, this current is caused by avalanche breakdown due to a sufficiently large voltage applied across the collector-base junction. It can be used intentionally in the design of certain ESD protection devices integrated onto semiconductor chips. According to the embodiment of the present invention, in addition, the first surge protection element S1 can be designed to have relatively low capacitance.

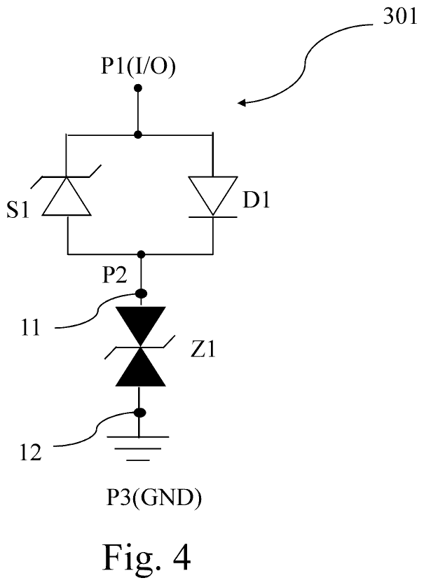

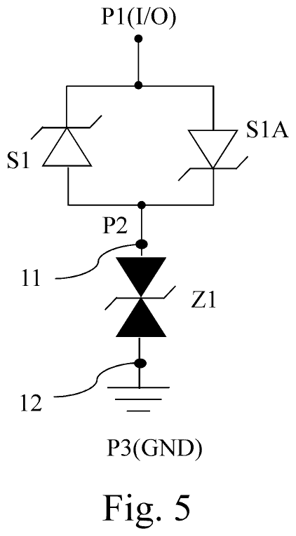

Please refer to FIG. 4, which schematically shows a circuit layout structural diagram of the proposed transient voltage suppressor circuit with low capacitance according to FIG. 3 when the first clamping element Z1 is a bi-directional device and the first pin P1 is electrically connected with an input and output (I/O) terminal I/O. At this time, the first pin P1 is coupled with the input and output (I/O) terminal I/O and is illustrated by “P1(I/O)” in the drawing. On the other hand, the third pin P3 will be electrically connected to a ground terminal GND and is illustrated by “P3(GND)” in the drawing. According to the embodiment of the present invention, the breakdown voltage of the first clamping element Z1 can be fine tuned based on the maximum reverse working voltage V_{rwm} at the input and output (I/O) terminal I/O. For instance, the first clamping element Z1 can be selected from a group consisting of a Zener diode, a bipolar junction transistor (BJT), a metal oxide semiconductor field effect transistor (MOSFET), and a silicon controlled rectifier (SCR). Furthermore, regarding the first control element D1 of the proposed transient voltage suppressor circuit with low capacitance, the first control element D1, for example, can be a diode as illustrated in FIG. 3 and FIG. 4. However, the present invention is certainly not limited thereto. According to other alternative embodiments of the present invention, the first control element D1 may also be a bipolar junction transistor (BJT), a silicon controlled rectifier (SCR), or the same element as the first surge protection element S1. Please refer to FIG. 5, in which FIG. 5 shows a variant embodiment of FIG. 4. As can be seen, FIG. 5 schematically shows another circuit layout structural diagram of the proposed transient voltage suppressor circuit with low capacitance according to FIG. 4 when the first control element S1A can be adopted by using the same element as the first surge protection element S1. In practical, according to the technical solution of the present invention, it should be understood that the first control element D1 can be alternatively selected from a group consisting of a diode, a bipolar junction transistor (BJT) and a silicon controlled rectifier (SCR), when necessary. In other words, people who are skilled in the art and having ordinary understandings and technical backgrounds to the present invention, are able to make various modifications or layout distributions depending on different circuit regulations and/or specifications without departing from the scope of the invention. That is to say, the present invention is certainly not limited thereto the disclosed embodiments. And the modified embodiments and/or circuit implementations if there is any, should still fall into the claim scope of the present invention.

As a result, at normal operation of the disclosed transient voltage suppressor circuit, the voltage drop across the first control element D1 would be less than 1 voltage (V). And due to the small voltage swing of the first control element D1, the capacitance variation of the capacitance at the I/O terminal C_{I/O} could be retained small.

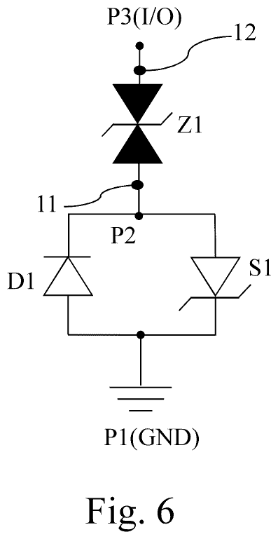

On the other hand, please refer to FIG. 6, in which FIG. 6 shows another feasible variant embodiment of FIG. 4. As can be seen, FIG. 6 schematically shows another circuit layout structural diagram of the proposed transient voltage suppressor circuit with low capacitance according to FIG. 3 when the first clamping element Z1 is a bi-directional device and the third pin P3 is electrically connected with an input and output (I/O) terminal I/O instead of the first pin P1 in FIG. 4. As can be seen in such a variant embodiment in FIG. 6, it may also be applicable that the third pin P3 is coupled with the input and output (I/O) terminal I/O, illustrated by “P3(I/O)” in the drawing, and the first pin P1 will be electrically connected to a ground terminal GND, as illustrated by “P1(GND)” in the drawing. And it is believed that such variant transient voltage suppressor circuit as disclosed in FIG. 6, is characterized by having low capacitance as well, and can be implemented to accomplish the inventive effects of the present invention.

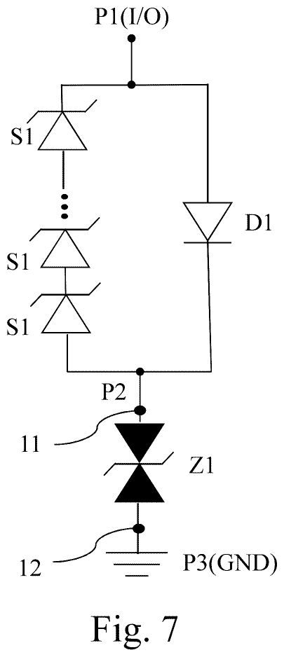

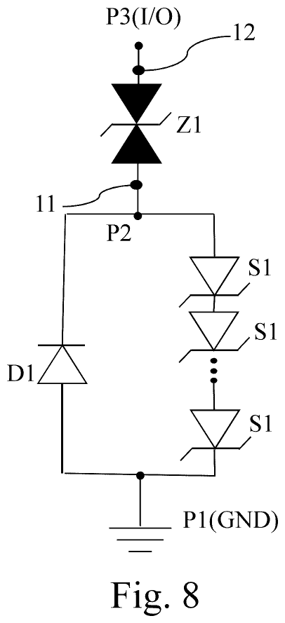

Moreover, in order to enhance the electrostatic discharge (ESD) robustness of the disclosed transient voltage suppressor circuit, the transient voltage suppressor circuit may alternatively further comprise a plurality of first surge protection elements S1 which are connected in series. For the detailed technical descriptions, please refer to FIG. 7, which schematically shows another circuit layout structural diagram of the proposed transient voltage suppressor circuit with low capacitance on the basis of FIG. 4 when a plurality of first surge protection elements S1 are further disposed in the transient voltage suppressor circuit. By employing the same design manners, FIG. 8 schematically shows a circuit layout structural diagram of the proposed transient voltage suppressor circuit with low capacitance on the basis of FIG. 6 when a plurality of first surge protection elements S1 are further disposed in the transient voltage suppressor circuit. As can be seen from both the modified embodiments in FIG. 7 and in FIG. 8, the plurality of first surge protection elements S1 are disposed and connected in cascade between the first end 11 of the first clamping element Z1 and the anode of the first control element D1. And the proposed transient voltage suppressor circuit with low capacitance is advantageous of having better electrostatic discharge (ESD) robustness due to the multiple serially connected first surge protection elements S1 further disposed in the transient voltage suppressor circuit.

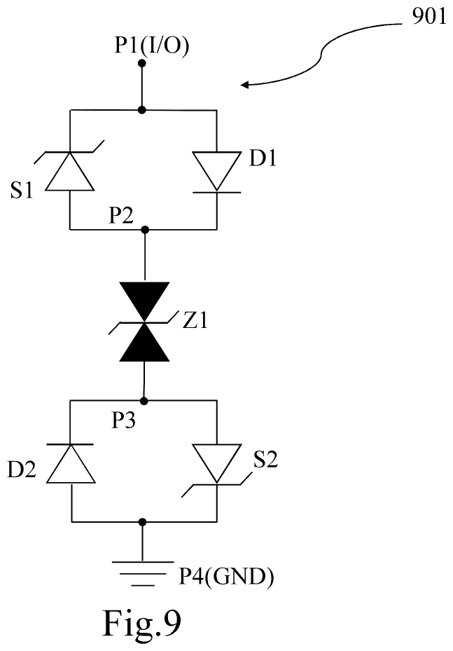

In addition, please refer to FIG. 9, which schematically shows a circuit layout structural diagram of a proposed transient voltage suppressor circuit with low capacitance in accordance with one another embodiment of the present invention. According to the modified embodiment of present invention, the proposed transient voltage suppressor circuit with low capacitance 901 is a modified circuit structure on a basis of the transient voltage suppressor circuit of the first embodiment in FIG. 3. In addition to the first control element D1, the first surge protection element S1 and the first clamping element Z1 as disposed in the transient voltage suppressor circuit 301, the proposed transient voltage suppressor circuit with low capacitance 901 in FIG. 9 further includes a second control element D2 and a second surge protection element S2. According to the embodiment in FIG. 9, an anode of the second control element D2 is further electrically coupled to a fourth pin P4, and a cathode of the second control element D2 is electrically coupled to the above mentioned third pin P3. In addition, the second surge protection element S2 is electrically connected in parallel with the second control element D2, wherein an anode of the second surge protection element S2 is electrically coupled to the third pin P3, and a cathode of the second surge protection element S2 is electrically coupled to the fourth pin P4.

According to the embodiment in FIG. 9, when the first clamping element Z1 is a bi-directional device and the first pin P1 is electrically connected with the input and output (I/O) terminal I/O, the fourth pin P4 is electrically connected to a ground terminal GND. As a result, according to the electrical connections thereof, as illustrated in the figure of FIG. 9, it is indicated by P1(I/O) and P4(GND) for better understanding.

As disclosed in the present invention, the second surge protection element S2 should be a uni-directional device having a snapback property. For example, the second surge protection element S2 can be alternatively selected from a group consisting of a bipolar junction transistor (BJT) and a silicon controlled rectifier (SCR). And the second control element D2 can be a diode, as illustrated in the embodiment in FIG. 9. Alternatively, the second control element D2 may be the same element as the second surge protection element S2 (see FIG. 5). In other words, generally, the second control element D2 can be selected from a group consisting of a diode, a bipolar junction transistor (BJT) and a silicon controlled rectifier (SCR). The present invention is not limited thereto. And furthermore, for a better electrostatic discharge (ESD) robustness of the disclosed transient voltage suppressor circuit, the proposed transient voltage suppressor circuit with low capacitance 901 may alternatively further comprise a plurality of second surge protection elements S2 which are connected in series as well. By employing the same design manners as disclosed in FIG. 7 and FIG. 8, a plurality of second surge protection elements S2 can be further disposed and connected in cascade between the first clamping element Z1 and the ground terminal GND. And such variant transient voltage suppressor circuit with low capacitance 901 is also advantageous of having better electrostatic discharge (ESD) robustness due to the multiple serially connected second surge protection elements S2 further disposed in the transient voltage suppressor circuit.

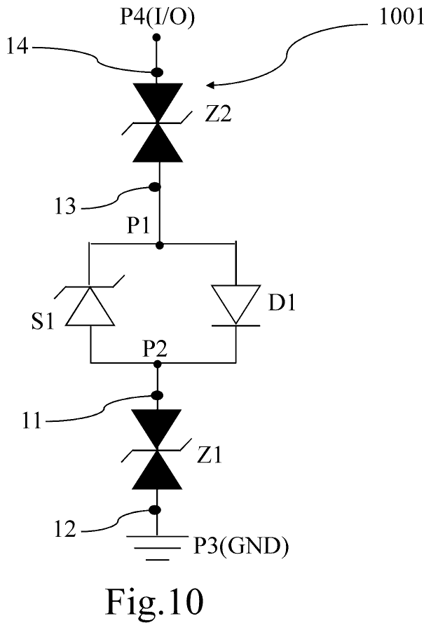

Furthermore, please refer to FIG. 10, which schematically shows another circuit layout structural diagram of a proposed transient voltage suppressor circuit with low capacitance in accordance with one yet another embodiment of the present invention. According to the modified embodiment of present invention, the proposed transient voltage suppressor circuit with low capacitance 1001 is another modified circuit structure on a basis of the transient voltage suppressor circuit of the first embodiment in FIG. 3. In addition to the first control element D1, the first surge protection element S1 and the first clamping element Z1 as disposed in the transient voltage suppressor circuit 301, the proposed transient voltage suppressor circuit with low capacitance 1001 in FIG. 10 further includes a second clamping element Z2, wherein the second clamping element Z2 is serially connected with the above mentioned first control element D1 in parallel with the first surge protection element S1. According to the variant embodiment as disclosed in FIG. 10, the second clamping element Z2 has a third end 13, which is coupled to the first pin P1. And, the second clamping element Z2 has a fourth end 14 which is opposite to the third end 13, and the fourth end 14 is electrically coupled to a fourth pin P4.

According to the embodiment in FIG. 10 of the present invention, when the first clamping element Z1 and the second clamping element Z2 are bi-directional devices and the fourth pin P4 is electrically connected with an input and output (I/O) terminal I/O, it is believed that the third pin P3 is electrically connected to a ground terminal GND. As a result, according to such electrical connections thereof, as illustrated in the figure of FIG. 10, it is indicated by P4(I/O) and P3(GND) for clear descriptions.

In addition, as disclosed in the present invention, the first clamping element Z1 and the second clamping element Z2 can be alternatively selected from a group consisting of a Zener diode, a bipolar junction transistor (BJT), a metal oxide semiconductor field effect transistor (MOSFET), and a silicon controlled rectifier (SCR). Many alternatives and modifications can be apparent to those skilled in the art, once informed by the present disclosure. And the present disclosure covers the alternatives and modifications in all equalities.

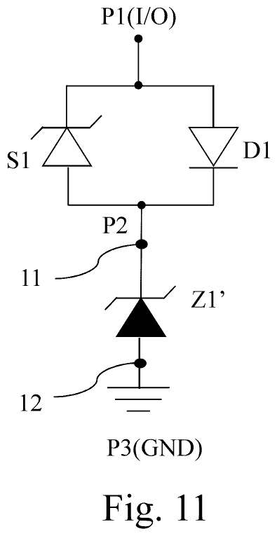

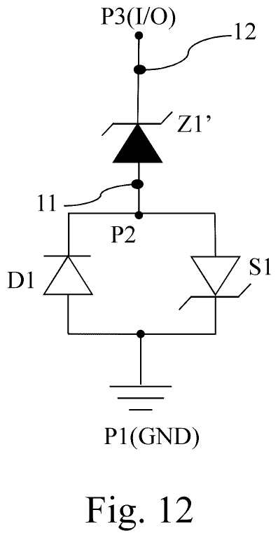

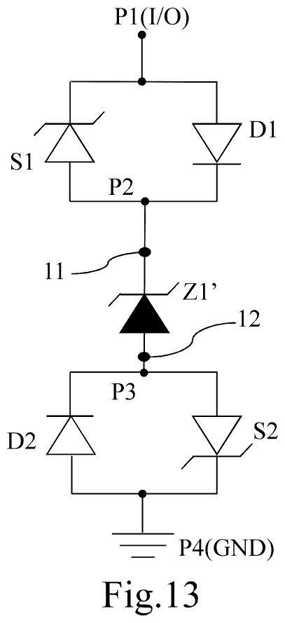

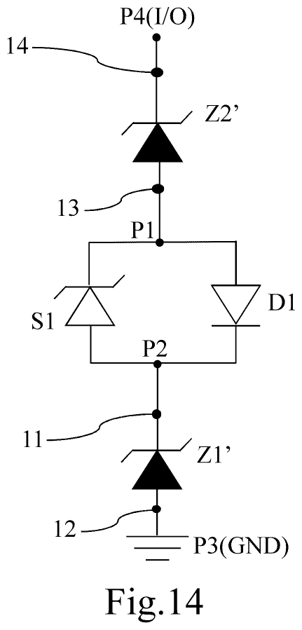

In another aspect, regarding the first clamping element Z1 in the previous embodiments, it should be understood that the first clamping element Z1 is not limited to a bi-directional device. According to other feasible embodiments of the present invention, it is believed that the first clamping element Z1 may also be a uni-directional device. Please refer to FIG. 11 to FIG. 14 of the present invention, wherein FIG. 11 is a modified embodiment from FIG. 4, FIG. 12 is a modified embodiment from FIG. 6, FIG. 13 is a modified embodiment from FIG. 9, and FIG. 14 is a modified embodiment from FIG. 10. According to the various embodiments of the present invention in FIG. 11 to FIG. 14, it can be seen that the first clamping element Z1′ and the second clamping element Z2′ are uni-directional devices instead of the previous bi-directional device. As indicated in the embodiment in FIG. 11, when the first clamping element Z1′ is a uni-directional device, and the first pin P1 is electrically connected with an input and output (I/O) terminal I/O, the third pin P3 is electrically connected to a ground terminal GND, it is illustrated by P1(I/O) and P3(GND) in the drawing. At this time, it is believed that the first end 11 of the first clamping element Z1′ is a cathode and the second end 12 of the first clamping element Z1′ is an anode.

In addition, FIG. 12 schematically shows a modified embodiment on the basis of FIG. 6, in which the first clamping element Z1′ is also a uni-directional device instead of a bi-directional device in FIG. 6. According to such embodiment, when the third pin P3 is electrically connected with the input and output (I/O) terminal I/O, which is illustrated by P3(I/O), the first pin P1 is electrically connected to a ground terminal GND, which is illustrated by P1(GND). It should be relevant that according to such embodiment, then the first end 11 of the first clamping element Z1′ is an anode, while the second end 12 of the first clamping element Z1′ is a cathode.

Moreover, please refer to FIG. 13, which schematically shows a modified embodiment on the basis of FIG. 9, in which the first clamping element Z1′ is also a uni-directional device instead of a bi-directional device in FIG. 9. According to such embodiment, when the first clamping element Z1′ is a uni-directional device, and the first pin P1 is electrically connected with the input and output (I/O) terminal I/O, which is illustrated by P1(I/O), the fourth pin P4 is electrically connected to a ground terminal GND, which is illustrated by P4(GND). It should be relevant that according to such embodiment, the first end 11 of the first clamping element Z1′ is a cathode and the second end 12 of the first clamping element Z1′ is an anode.

And moreover, please refer to FIG. 14, in which FIG. 14 schematically shows another modified embodiment on the basis of FIG. 10. According to the embodiment as shown in FIG. 14, it is obvious that the first clamping element Z1′ and the second clamping element Z2′ are both uni-directional devices instead of the bi-directional devices in FIG. 10. According to such embodiment, when the first clamping element Z1′ and the second clamping element Z2′ are uni-directional devices, and the fourth pin P4 is electrically connected with the input and output (I/O) terminal I/O, which is illustrated by P4(I/O), the third pin P3 is electrically connected to a ground terminal GND, which is illustrated by P3(GND). It is believed that according to such embodiment as illustrated in FIG. 14, then the first end 11 of the first clamping element Z1′ is a cathode, the second end 12 of the first clamping element Z1′ is an anode, the third end 13 of the second clamping element Z2′ is an anode and the fourth end 14 of the second clamping element Z2′ is a cathode.

To sum up, as disclosed in the above mentioned plurality of variant embodiments of the present invention in FIG. 11, FIG. 12, FIG. 13 and FIG. 14, it is believed that the first and second clamping elements of the transient voltage suppressor circuit can be either a uni-directional device or a bi-directional device. And these various and variant transient voltage suppressor circuit as disclosed in FIG. 11 to FIG. 14, are also characterized by having low capacitance as well, and can be implemented to accomplish the inventive effects of the present invention.

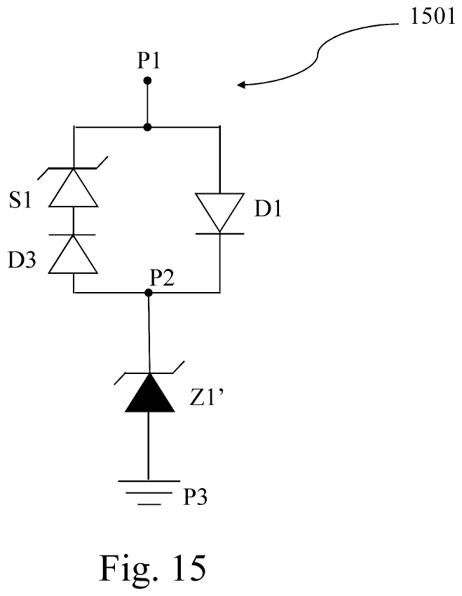

Furthermore, in order to further expand the practical fields of the present invention, the Applicants of the invention, in the following paragraphs, further provide a plurality of alternative and feasible embodiments of the present invention for your references. Please refer to FIG. 15, which schematically shows a circuit layout structural diagram of a proposed transient voltage suppressor circuit with low capacitance in accordance with one another embodiment of the present invention. According to such embodiment of present invention, the proposed transient voltage suppressor circuit with low capacitance 1501 is a modified circuit structure on a basis of the transient voltage suppressor circuit of the previously disclosed embodiment in FIG. 11. In addition to the first control element D1, the first surge protection element S1 and the first clamping element Z1′ as disposed in the transient voltage suppressor circuit in FIG. 11, the proposed transient voltage suppressor circuit with low capacitance 1501 in FIG. 15 further includes a third control element D3. According to the embodiment of FIG. 15, the proposed third control element D3 is further disposed and the third control element D3 is electrically connected between the second pin P2 and the first surge protection element S1. More specifically, the third control element D3 is configured as being electrically connected in series with the first surge protection element S1.

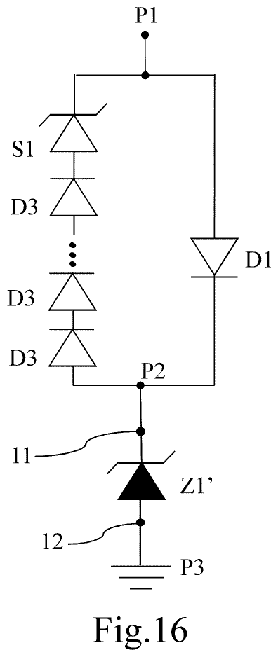

In one embodiment, for instance, the third control element D3, can be a diode as illustrated in FIG. 15, wherein an anode of the third control element D3 is electrically coupled to the second pin P2, and a cathode of the third control element D3 is electrically coupled to the anode of the first surge protection element S1. Furthermore, according to an alternative embodiment of the present invention on the basis of FIG. 15, then the proposed transient voltage suppressor circuit may further include a plurality of the third control elements D3 which are connected in series, and the plurality of the third control elements D3 are connected in cascade between the first end 11 of the first clamping element Z1′ and the anode of the first surge protection element S1, as illustrated in FIG. 16, in order to obtain a better electrostatic discharge (ESD) robustness of the disclosed transient voltage suppressor circuit.

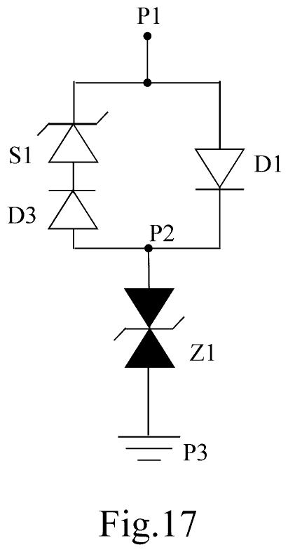

Moreover, FIG. 17 shows another modified circuit structure on a basis of the disclosed transient voltage suppressor circuit in FIG. 15. As can be seen in the embodiment in FIG. 17, while compared to the first clamping element Z1′ as a uni-directional device in FIG. 15, alternatively, the first clamping element Z1 can be a bi-directional device. And such variant embodiment can be also adopted for accomplishing the inventive effects of the present invention.

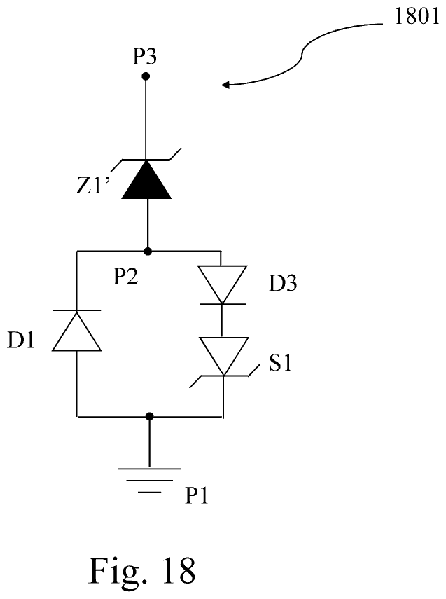

By employing certain similar circuit design manners, please refer to FIG. 18, which schematically shows a circuit layout structural diagram of a proposed transient voltage suppressor circuit with low capacitance in accordance with one another embodiment of the present invention. According to such embodiment of present invention, the proposed transient voltage suppressor circuit with low capacitance 1801 is a modified circuit structure on a basis of the transient voltage suppressor circuit of the previously disclosed embodiment in FIG. 12. In addition to the first control element D1, the first surge protection element S1 and the first clamping element Z1′ as disposed in the transient voltage suppressor circuit in FIG. 12, the proposed transient voltage suppressor circuit with low capacitance 1801 in FIG. 18 may further include a third control element D3. According to the embodiment of FIG. 18, the proposed third control element D3 is further disposed and the third control element D3 is electrically connected between the second pin P2 and the first surge protection element S1. In specific, the third control element D3 is electrically connected in series with the first surge protection element S1.

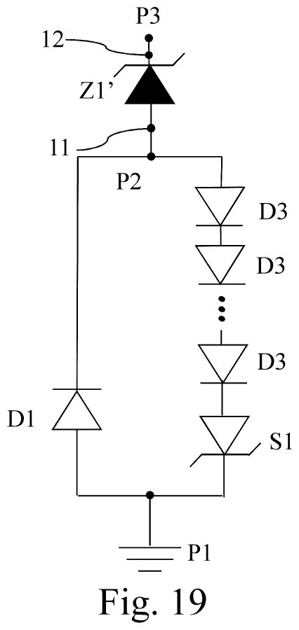

In one embodiment, for instance, the third control element D3, can be a diode as illustrated in FIG. 18, wherein an anode of the third control element D3 is electrically coupled to the second pin P2, and a cathode of the third control element D3 is electrically coupled to the anode of the first surge protection element S1. Furthermore, according to an alternative embodiment of the present invention on the basis of FIG. 18, then the proposed transient voltage suppressor circuit may further include a plurality of the third control elements D3 which are connected in series, and the plurality of the third control elements D3 are connected in cascade between the first end 11 of the first clamping element Z1′ and the anode of the first surge protection element S1, as illustrated in FIG. 19, in order to obtain a better electrostatic discharge (ESD) robustness of the disclosed transient voltage suppressor circuit.

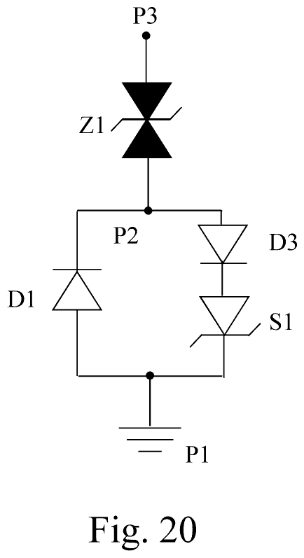

Moreover, FIG. 20 shows another modified circuit structure on a basis of the disclosed transient voltage suppressor circuit in FIG. 18. As can be seen in the embodiment in FIG. 20, while compared to the first clamping element Z1′ as a uni-directional device in FIG. 18, alternatively, the first clamping element Z1 can be a bi-directional device. And such variant embodiment can be also adopted for accomplishing the inventive effects of the present invention.

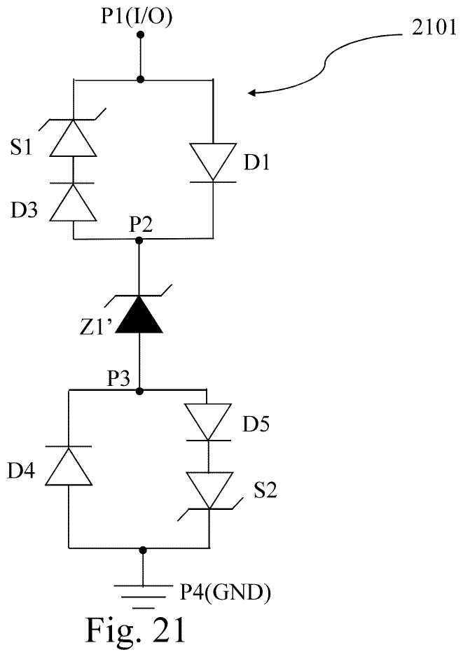

In addition, please refer to FIG. 21 for one another practical embodiment of the present invention, wherein FIG. 21 schematically shows a circuit layout structural diagram of a proposed transient voltage suppressor circuit with low capacitance in accordance with a modified circuit structure on a basis of the transient voltage suppressor circuit of the previously disclosed embodiment in FIG. 11. In addition to the first control element D1, the first surge protection element S1 and the first clamping element Z1′ as disposed in the transient voltage suppressor circuit in FIG. 11, the proposed transient voltage suppressor circuit with low capacitance 2101 in FIG. 21 further comprises: a third control element D3, a fourth control element D4, a second surge protection element S2 and a fifth control element D5.

According to the embodiment as shown in FIG. 21, the third control element D3 is electrically connected between the second pin P2 and the first surge protection element S1, and the third control element D3 is electrically connected in series with the first surge protection element S1. As illustrated, when the first clamping element Z1′ is a uni-directional device, an anode of the fourth control element D4 is electrically coupled to a fourth pin P4 and a cathode of the fourth control element D4 is electrically coupled to the third pin P3. In addition, the fifth control element D5 is electrically connected between the third pin P3 and the second surge protection element S2, and the fifth control element D5 is also electrically connected in series with the second surge protection element S2. According to the embodiment of FIG. 21, when the first clamping element Z1′ is a uni-directional device, and the first pin P1 is electrically connected with an input and output (I/O) terminal I/O, which is indicated by P1(I/O) in the figure, it is believed that the fourth pin P4 is electrically connected to a ground terminal GND and is illustrated by P4(GND) in the figure. According to such an embodiment in FIG. 21, at this time, an anode of the fifth control element D5 is electrically coupled to the third pin P3, a cathode of the fifth control element D5 is electrically coupled to an anode of the second surge protection element S2, and a cathode of the second surge protection element S2 is electrically coupled to the fourth pin P4, which is the ground terminal.

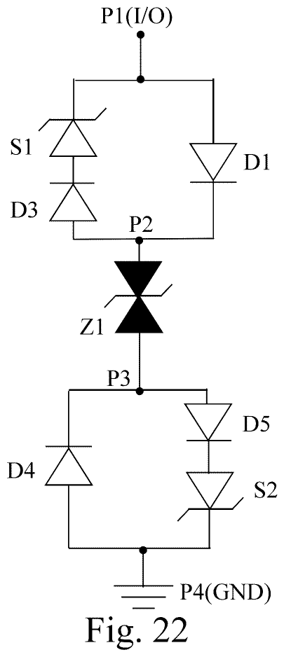

Nevertheless, the first clamping element is not limited to a uni-directional device. A bi-directional device can be adopted as well for implementing the circuit structure of the proposed transient voltage suppressor circuit with low capacitance of the present invention. And FIG. 22 shows the modified circuit structure on a basis of the disclosed transient voltage suppressor circuit in FIG. 21, when the first clamping element Z1 is a bi-directional device instead of the first clamping element Z1′ as a uni-directional device in FIG. 21. As can be seen, it is believed that such variant embodiment can be also adopted for accomplishing the inventive effects of the present invention.

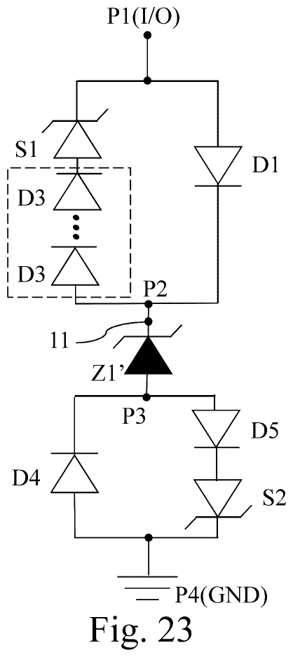

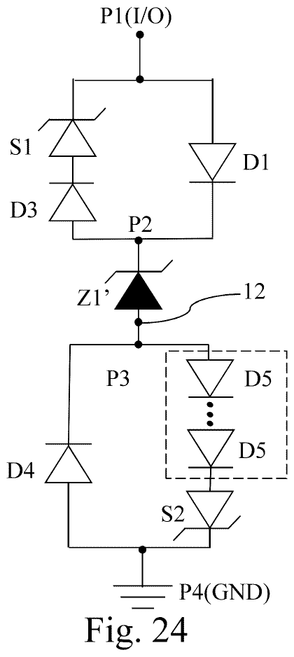

In addition, according to the disclosed embodiment as provided in FIG. 21, in order to enhance and improve the electrostatic discharge (ESD) robustness of the disclosed transient voltage suppressor circuit, a plurality of third control elements D3 can be further disposed and connected in series between the first end 11 of the first clamping element Z1′ and the anode of the first surge protection element S1 as shown in FIG. 23. By employing the similar design techniques, FIG. 24 shows another modified embodiment of the present invention from FIG. 21, when a plurality of the fifth control elements D5 are connected in series between the second end 12 of the first clamping element Z1′ and the anode of the second surge protection element S2 so as to enhance and improve the electrostatic discharge (ESD) robustness of the disclosed transient voltage suppressor circuit. It should be noted that for people who have ordinary skills and technical backgrounds of the invention, it is to be relevant that both multiple third control elements D3 and multiple fifth control elements D5 can be configured at the same time in one transient voltage suppressor circuit scheme for a better ESD robustness, and can also be applied to the embodiment when the first clamping element is a bi-directional device (FIG. 22), so the Applicants of the invention omit the redundant descriptions thereto.

As disclosed in these applicable embodiments of the present invention, the first surge protection element S1 and the second surge protection element S2 are uni-directional devices having a snapback property. For instance, each of the first surge protection element S1 and the second surge protection element S2 can be alternatively selected from a group consisting of a bipolar junction transistor (BJT) and a silicon controlled rectifier (SCR).

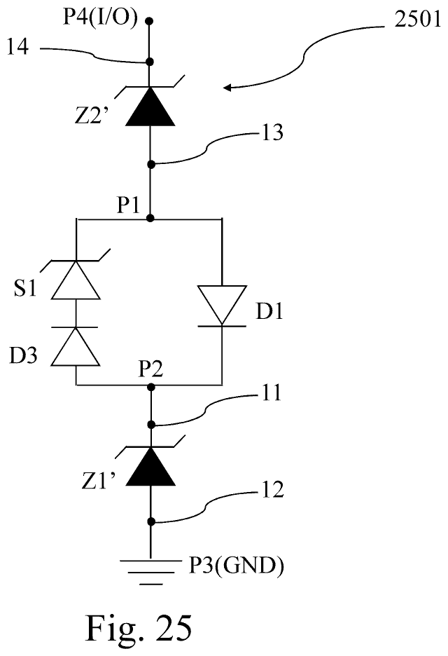

Moreover, please proceed to refer to FIG. 25, which additionally shows another circuit layout structural diagram of a proposed transient voltage suppressor circuit with low capacitance in accordance with one another embodiment of the present invention. According to such embodiment of present invention, the proposed transient voltage suppressor circuit with low capacitance 2501 is a modified circuit structure on a basis of the transient voltage suppressor circuit of the previously disclosed embodiment in FIG. 11. In addition to the first control element D1, the first surge protection element S1 and the first clamping element Z1′ as disposed in the transient voltage suppressor circuit in FIG. 11, the proposed transient voltage suppressor circuit with low capacitance 2501 in FIG. 25 further includes a third control element D3 and a second clamping element Z2′, wherein the second clamping element Z2′ has a third end 13 coupled to the first pin P1 and a fourth end 14 which is opposite to the third end 13, and the fourth end 14 is electrically coupled to a fourth pin P4.

According to the embodiment of FIG. 25, the third control element D3 is electrically connected between the second pin P2 and the first surge protection element S1, and the third control element D3 is further electrically connected in series with the first surge protection element S1. As illustrated, when the first clamping element Z1′ and the second clamping element Z2′ are uni-directional devices, the fourth pin P4 is electrically connected with an input and output (I/O) terminal I/O and the third pin P3 is electrically connected to a ground terminal GND. It is illustrated as P4(I/O) and P3(GND), respectively in FIG. 25. At this time, according to such another variant embodiment of the present invention, the first end 11 of the first clamping element Z1′ is a cathode, the second end 12 of the first clamping element Z1′ is an anode, the third end 13 of the second clamping element Z2′ is an anode and the fourth end 14 of the second clamping element Z2′ is a cathode.

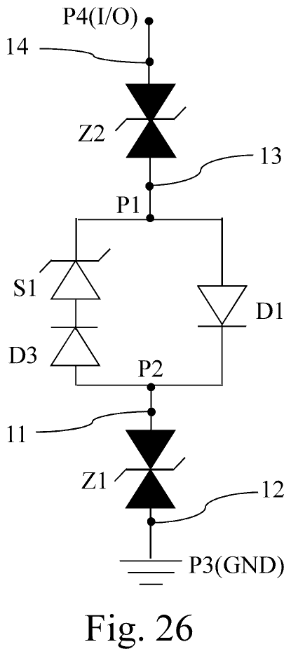

According to the technical characteristics of the present invention, the first clamping element Z1′ and the second clamping element Z2′ are not limited to uni-directional devices, but also can be bi-directional devices as disclosed in a modified circuit scheme of the present invention in FIG. 26, wherein the first clamping element Z1 and the second clamping element Z2 are implemented as bi-directional devices.

According to the applicable embodiments in FIG. 25 and FIG. 26, it is believed that the first clamping element Z1, Z1′ and the second clamping element Z2, Z2′ can be alternatively selected from a group consisting of a Zener diode, a bipolar junction transistor (BJT), a metal oxide semiconductor field effect transistor (MOSFET), and a silicon controlled rectifier (SCR) depending on various circuit requirements. And the breakdown voltage of the first clamping element Z1, Z1′ and of the second clamping element Z2, Z2′ can be fine tuned based on the maximum reverse working voltage V_{rwm} at the input and output (I/O) terminal I/O.

Also, regarding the applicable embodiments in both FIG. 25 and FIG. 26, a plurality of the third control elements D3 can be additionally configured and connected in series, such that the plurality of the third control elements D3 are connected in cascade between the first end 11 of the first clamping element Z1, Z1′ and the anode of the first surge protection element S1 for improving the ESD robustness of the disclosed transient voltage suppressor circuit structure.

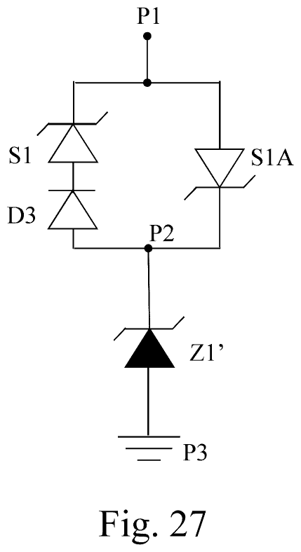

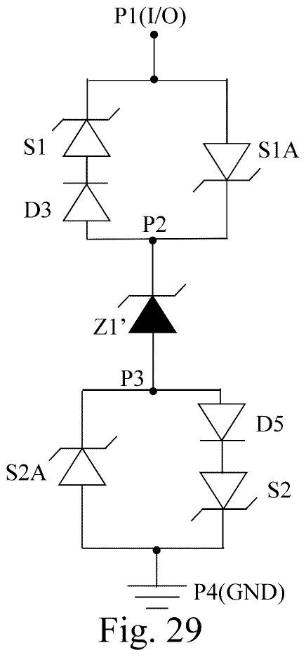

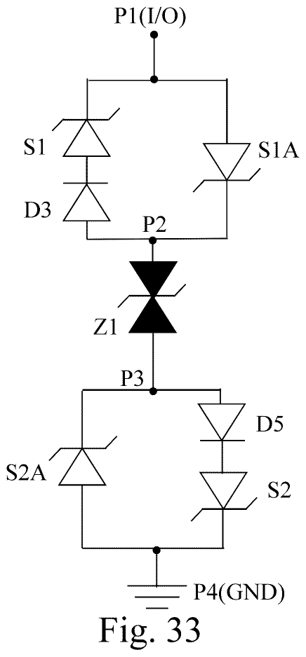

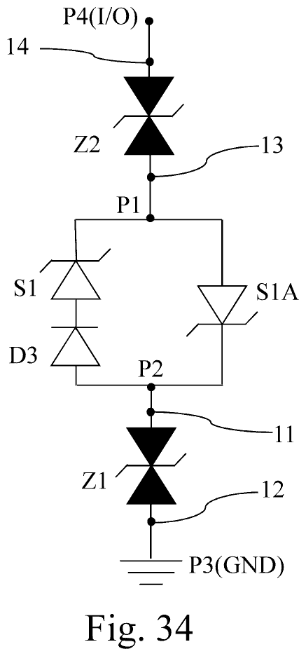

In addition, as previously provided in the embodiments of FIG. 15 to FIG. 26 of the present invention, it is explanatory that the first control element D1, the third control element D3, the fourth control element D4 and the fifth control element D5 are implemented each as a diode. However, the present invention is not limited thereto. According to many alternatives and variations of the present invention, the first control element D1, the third control element D3, the fourth control element D4 and the fifth control element D5 may be alternatively selected from a group consisting of a diode, a bipolar junction transistor (BJT) and a silicon controlled rectifier (SCR). For instance, the first control element D1 can be selected as the same element as the first surge protection element S1. Please refer to the following embodiments of the present invention, as disclosed in FIG. 27~FIG. 34, wherein when the first control element S1A can be adopted by using the same element as the first surge protection element S1. By considering the same circuit design manners, the fourth control element D4 in FIG. 29 and FIG. 33 can be selected as the same element as the second surge protection element S2, indicating that the fourth control element S2A can be adopted by using the same element as the second surge protection element S2. And it is believed that these variant embodiments are also applicable for implementation of the disclosed transient voltage suppressor circuit with low capacitance of the present invention.

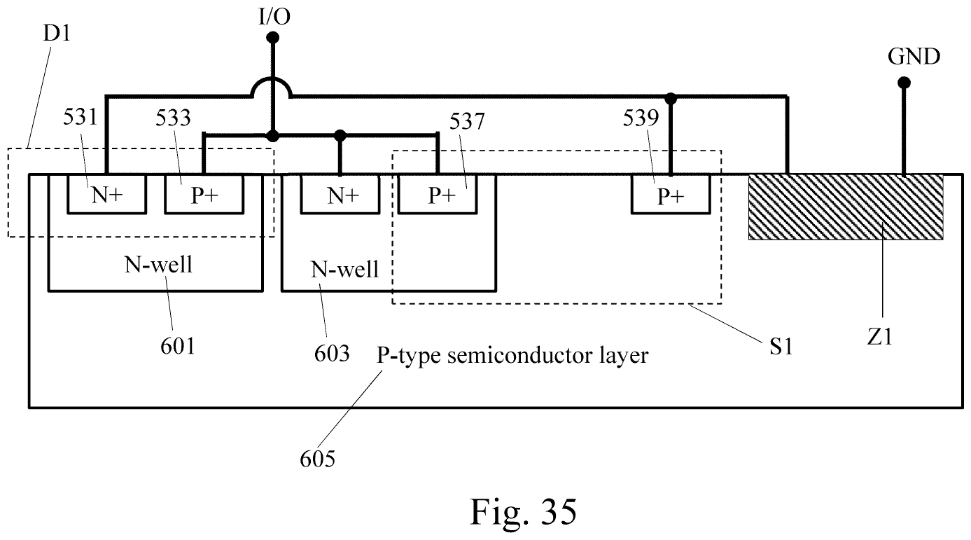

In another aspect, as disclosed in the following detailed descriptions, the Applicants of the present invention further provide a plurality of fabrication process layouts for implementations of the disclosed transient voltage suppressor circuit with low capacitance of the present invention. Please refer to FIG. 35 first, which schematically shows a layout structural diagram of a proposed transient voltage suppressor circuit with low capacitance in accordance with one applicable embodiment of the present invention. As can be seen, the first control element D1 as disclosed in the embodiment of the present invention, for example, a diode, can be constructed by an N-type heavily doped region (N+) 531 and a P-type heavily doped region (P+) 533 in the N-type well region (N-well) 601. And the first surge protection element S1 as disclosed in the embodiment of the present invention, for instance, can be implemented as a uni-directional P-type bipolar junction transistor (BJT) device, which is constructed by a P-type heavily doped region (P+) 537 in the N-type well region (N-well) 603, the N-type well region (N-well) 603, the P-type semiconductor layer 605 and the P-type heavily doped region (P+) 539 in the P-type semiconductor layer 605. According to the embodiment of the present invention, the P-type semiconductor layer 605 for example, can be alternatively a P-type substrate layer, or a P-type epitaxial layer. The present invention is not limited thereto and is characterized by a variety of possible process flexibilities.

In general, by employing the P-type heavily doped region (P+) 537 in the N-type well region (N-well) 603, the first surge protection element S1 (i.e. the P-type bipolar junction transistor), is able to have the snapback property. Also, the first surge protection element S1 is able to be designed with low capacitance due to and defined by the p-n junction of the N-type well region (N-well) 603 and the P-type semiconductor layer 605.

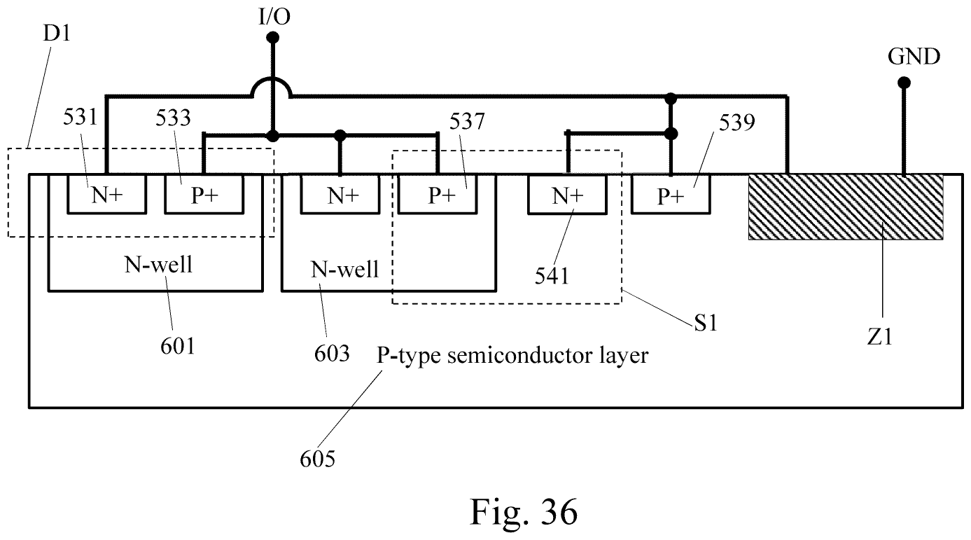

In addition, FIG. 36 schematically shows another layout structural diagram of a proposed transient voltage suppressor circuit with low capacitance in accordance with one another applicable embodiment of the present invention. As can be seen, by adding an N-type heavily doped region (N+) 541 in the P-type semiconductor layer 605 and electrically connecting the N-type heavily doped region (N+) 541 in common with the P-type heavily doped region (P+) 539, the accordingly formed first surge protection element S1 in FIG. 36 can be a p-n-p-n silicon controlled rectifier (SCR) device. And the first surge protection element S1 (i.e. the p-n-p-n silicon controlled rectifier device) is constructed by the P-type heavily doped region (P+) 537, the N-type well region (N-well) 603, the P-type semiconductor layer 605 and the N-type heavily doped region (N+) 541. Also, the first surge protection element S1 is able to be designed with low capacitance due to and defined by the p-n junction of the N-type well region (N-well) 603 and the P-type semiconductor layer 605.

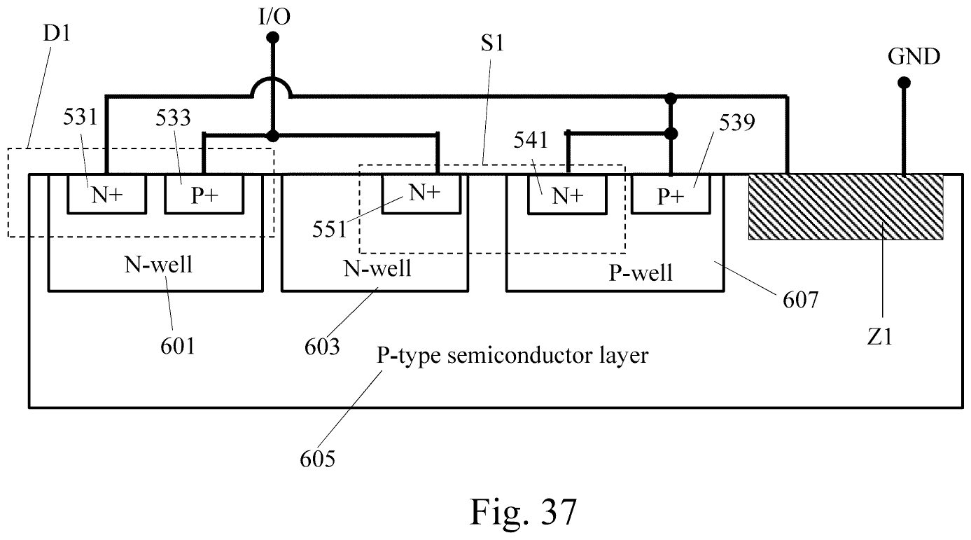

Furthermore, the first surge protection element S1 is not limited to the uni-directional P-type bipolar junction transistor (BJT) device as disclosed in FIG. 35. According to another alternative embodiment of the present invention, the first surge protection element S1 may also be a uni-directional N-type bipolar junction transistor (BJT) device as disclosed in FIG. 37. Please refer to FIG. 37, in which an N-type heavily doped region (N+) 551 is further configured in the N-type well region (N-well) 603 and a P-type well region (P-well) 607 is further provided for accommodating the N-type heavily doped region (N+) 541 in common with the P-type heavily doped region (P+) 539. According to such configurations, it is believed that the first surge protection element S1 (i.e. the uni-directional N-type bipolar junction transistor device) is constructed by the N-type heavily doped region (N+) 551, the N-type well region (N-well) 603, the P-type semiconductor layer 605, the P-type well region (P-well) 607, and the N-type heavily doped region (N+) 541. Also, the first surge protection element S1 is able to be designed with low capacitance due to and defined by the p-n junction of the N-type well region (N-well) 603 and the P-type semiconductor layer 605.

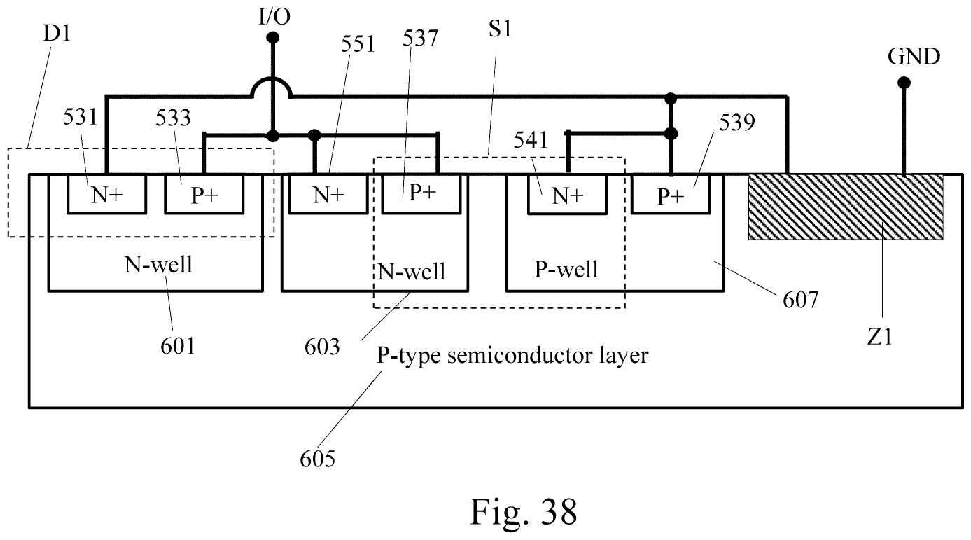

And furthermore, FIG. 38 additionally shows another layout structural diagram of a proposed transient voltage suppressor circuit with low capacitance in accordance with one another applicable embodiment of the present invention. As can be seen, by adding a P-type heavily doped region (P+) at the anode of the uni-directional N-type bipolar junction transistor (BJT) device in FIG. 37, the accordingly formed first surge protection element S1 in FIG. 38 can be a p-n-p-n silicon controlled rectifier (SCR) device, which is constructed by the P-type heavily doped region (P+) 537, the N-type well region (N-well) 603, the P-type semiconductor layer 605, the P-type well region (P-well) 607 and the N-type heavily doped region (N+) 541. Moreover, the first surge protection element S1 is also able to be designed with low capacitance due to and defined by the p-n junction of the N-type well region (N-well) 603 and the P-type semiconductor layer 605.

As a result, it is believed that the disclosed transient voltage suppressor circuit structure of the present invention is characterized by having a steering diode design module and thus having relatively low capacitance. Since the first clamping elements Z1, Z1′ and the second clamping element Z2, Z2′ (for instance, a Zener diode, a bipolar junction transistor (BJT), a metal oxide semiconductor field effect transistor (MOSFET), or a silicon controlled rectifier (SCR)) are configured and employed to tolerate most of the voltage drops, and can be designed to have various breakdown voltages according to various maximum reverse working voltage V_{rwm} at the input and output (I/O) terminal I/O, the disclosed transient voltage suppressor circuit structure will be not affected by parasitic RC delay time when an electrostatic discharge (ESD) event is generated. As a result, the first surge protection element (and the second surge protection element) disposed in the disclosed transient voltage suppressor circuit structure will not be damaged and can be under well protection when the electrostatic discharge (ESD) event is generated.

Apart from the above, a plurality of the surge protection elements connected in cascade, and/or a surge protection element in series connection with a plurality of diodes, may be alternatively adopted for further decreasing the capacitance of the steering diode structure, thereby enhancing the electrostatic discharge (ESD) robustness of the disclosed transient voltage suppressor circuit structure of the present invention. Hereinafter, as can be seen from these variety of embodiments, it is believed that the present invention is aimed to propose and provide a great number of merits and advantages which can be accomplished by adopting the disclosed transient voltage suppressor circuit structure of the present invention. Therefore, in view of all, it should be obvious that the present invention is not only novel and inventive while compared to the prior arts, but also believed to be advantageous of solving and avoiding the conventional issues existing in the prior arts. And therefore, when compared to the prior arts, it is ensured that the present invention apparently shows much more effective performances than before.

As a result, to sum up, according to the technical contents of the present invention, the Applicants of the present invention have provided a plurality of feasible embodiments in the above-mentioned paragraphs for implementing the inventive effect of the invention for your references. It is apparent that, while compared to the conventional prior arts, the present invention is characterized by providing a transient voltage suppressor structure which is not affected by the RC delay time when a transient event takes place, such that it is able to avoid its surge protection element from being damaged. In addition, as can be seen from the plurality of embodiments, it is obvious that the technical spirits of the present invention include providing a relatively low capacitance of the transient voltage suppressor circuit structure. Moreover, by serially connecting a multiple of surge protection elements in cascade or connecting a series of diodes in cascade with one surge protection element, the electrostatic discharge (ESD) robustness of the disclosed transient voltage suppressor circuit structure of the present invention can be further improved significantly. Many various layout requirements modified by people skilled in the technical backgrounds can be determined. As a result, it is evident that the Applicants of the present invention have disclosed a plurality of applicable embodiments, which are advantageous of having extraordinary layout flexibility and can be composed of a variety of layout designs. Accordingly, in view of the technical contents and manners disclosed in the present invention without departing from the spirits of the present invention, it is believed that those skilled in the art and having general knowledge are able to make appropriate modifications or variations based on necessary circuit layout requirements, and the present invention is not restricted by the certain limited configurations and/or circuit diagrams as disclosed in the embodiments of the present invention. As a result, either the modifications or the variations should still fall into the scope of the present invention, and the present invention covers the modifications and its equality.

More specifically, according to the technical characteristics of the present invention which have been provided by the Applicants as illustrated in the previous paragraphs, it is obvious that the disclosed transient voltage suppressor circuit with low capacitance is effective and shows much more effective performances than before as compared to the prior arts. As a result, it is believed that the present invention is apparently instinct, effective and highly competitive for IC technology and industries in the market nowadays, whereby having extraordinary availability and competitiveness for future industrial developments and being in condition for early allowance.

As a result, to sum up, it should be noted that according to the foregoing disclosed technical contents provided by the Applicant, the present invention is certainly not limited thereto by the above-mentioned embodiments. In other words, for people who are skilled in the art and having ordinary understandings and technical backgrounds to the present invention, it would be allowed for them to make various modifications or changes depending on different circuit regulations and/or specifications without departing from the scope of the invention. That is to say, the present invention is certainly not limited thereto. And the variant embodiments and/or circuit implementations should still fall into the claim scope of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A transient voltage suppressor circuit with low capacitance, comprising:
a first control element, wherein an anode of the first control element is electrically coupled to a first pin, and a cathode of the first control element is electrically coupled to a second pin;
a first surge protection element, which is electrically connected in parallel with the first control element, wherein an anode of the first surge protection element is electrically coupled to the second pin, and a cathode of the first surge protection element is electrically coupled to the first pin; and
a first clamping element, which is serially connected with the first control element in parallel with the first surge protection element, wherein the first clamping element has a first end coupled to the second pin and a second end coupled to a third pin.

2. The transient voltage suppressor circuit with low capacitance according to claim 1, wherein the first surge protection element is a uni-directional device having a snapback property.

3. The transient voltage suppressor circuit with low capacitance according to claim 1, wherein the first surge protection element is selected from a group consisting of a bipolar junction transistor (BJT) and a silicon controlled rectifier (SCR).

4. The transient voltage suppressor circuit with low capacitance according to claim 1, wherein the first control element is selected from a group consisting of a diode, a bipolar junction transistor (BJT) and a silicon controlled rectifier (SCR).

5. The transient voltage suppressor circuit with low capacitance according to claim 1, wherein the first clamping element is selected from a group consisting of a Zener diode, a bipolar junction transistor (BJT), a metal oxide semiconductor field effect transistor (MOSFET), and a silicon controlled rectifier (SCR).

6. The transient voltage suppressor circuit with low capacitance according to claim 1, wherein when the first clamping element is a bi-directional device and the first pin is electrically connected with an input and output (I/O) terminal, the third pin is electrically connected to a ground terminal.

7. The transient voltage suppressor circuit with low capacitance according to claim 1, wherein when the first clamping element is a bi-directional device and the third pin is electrically connected with an input and output (I/O) terminal, the first pin is electrically connected to a ground terminal.

8. The transient voltage suppressor circuit with low capacitance according to claim 1, further comprising a plurality of the first surge protection elements which are connected in series, and the plurality of the first surge protection elements are connected in cascade between the first end of the first clamping element and the anode of the first control element.

9. The transient voltage suppressor circuit with low capacitance according to claim 1, further comprising:
a second control element, wherein an anode of the second control element is electrically coupled to a fourth pin, and a cathode of the second control element is electrically coupled to the third pin; and
a second surge protection element, which is electrically connected in parallel with the second control element, wherein an anode of the second surge protection element is electrically coupled to the third pin, and a cathode of the second surge protection element is electrically coupled to the fourth pin.

10. The transient voltage suppressor circuit with low capacitance according to claim 9, wherein when the first clamping element is a bi-directional device and the first pin is electrically connected with an input and output (I/O) terminal, the fourth pin is electrically connected to a ground terminal.

11. The transient voltage suppressor circuit with low capacitance according to claim 9, wherein the second surge protection element is a uni-directional device having a snapback property.

12. The transient voltage suppressor circuit with low capacitance according to claim 9, wherein the second surge protection element is selected from a group consisting of a bipolar junction transistor (BJT) and a silicon controlled rectifier (SCR).

13. The transient voltage suppressor circuit with low capacitance according to claim 9, wherein the second control element is selected from a group consisting of a diode, a bipolar junction transistor (BJT) and a silicon controlled rectifier (SCR).

14. The transient voltage suppressor circuit with low capacitance according to claim 1, further comprising a second clamping element, which is serially connected with the first control element in parallel with the first surge protection element, wherein the second clamping element has a third end coupled to the first pin and a fourth end coupled to a fourth pin.

15. The transient voltage suppressor circuit with low capacitance according to claim 14, wherein when the first clamping element and the second clamping element are bi-directional devices and the fourth pin is electrically connected with an input and output (I/O) terminal, the third pin is electrically connected to a ground terminal.

16. The transient voltage suppressor circuit with low capacitance according to claim 14, wherein the first clamping element and the second clamping element are selected from a group consisting of a Zener diode, a bipolar junction transistor (BJT), a metal oxide semiconductor field effect transistor (MOSFET), and a silicon controlled rectifier (SCR).

17. The transient voltage suppressor circuit with low capacitance according to claim 1, wherein when the first clamping element is a uni-directional device, and the first pin is electrically connected with an input and output (I/O) terminal, the third pin is electrically connected to a ground terminal, the first end of the first clamping element is a cathode and the second end of the first clamping element is an anode.

18. The transient voltage suppressor circuit with low capacitance according to claim 1, wherein when the first clamping element is a uni-directional device, and the third pin is electrically connected with an input and output (I/O) terminal, the first pin is electrically connected to a ground terminal, the first end of the first clamping element is an anode and the second end of the first clamping element is a cathode.

19. The transient voltage suppressor circuit with low capacitance according to claim 9, wherein when the first clamping element is a uni-directional device, and the first pin is electrically connected with an input and output (I/O) terminal, the fourth pin is electrically connected to a ground terminal, the first end of the first clamping element is a cathode and the second end of the first clamping element is an anode.

20. The transient voltage suppressor circuit with low capacitance according to claim 14, wherein when the first clamping element and the second clamping element are uni-directional devices, and the fourth pin is electrically connected with an input and output (I/O) terminal, the third pin is electrically connected to a ground terminal, the first end of the first clamping element is a cathode, the second end of the first clamping element is an anode, the third end of the second clamping element is an anode and the fourth end of the second clamping element is a cathode.

21. The transient voltage suppressor circuit with low capacitance according to claim 17, further comprising a third control element which is electrically connected between the second pin and the first surge protection element, and the third control element is electrically connected in series with the first surge protection element.

22. The transient voltage suppressor circuit with low capacitance according to claim 17, further comprising a plurality of third control elements which are connected in series, and the plurality of third control elements are connected in cascade between the first end of the first clamping element and the anode of the first surge protection element.

23. The transient voltage suppressor circuit with low capacitance according to claim 21, wherein the third control element is a diode and an anode of the third control element is electrically coupled to the second pin, and a cathode of the third control element is electrically coupled to the anode of the first surge protection element.

24. The transient voltage suppressor circuit with low capacitance according to claim 18, further comprising a third control element which is electrically connected between the second pin and the first surge protection element, and the third control element is electrically connected in series with the first surge protection element.

25. The transient voltage suppressor circuit with low capacitance according to claim 18, further comprising a plurality of third control elements which are connected in series, and the plurality of third control elements are connected in cascade between the first end of the first clamping element and the anode of the first surge protection element.

26. The transient voltage suppressor circuit with low capacitance according to claim 24, wherein the third control element is a diode and an anode of the third control element is electrically coupled to the second pin, and a cathode of the third control element is electrically coupled to the anode of the first surge protection element.

27. The transient voltage suppressor circuit with low capacitance according to claim 1, further comprising: a third control element, a fourth control element, a second surge protection element and a fifth control element, wherein the third control element is electrically connected between the second pin and the first surge protection element, and the third control element is electrically connected in series with the first surge protection element, and an anode of the third control element is electrically coupled to the second pin and a cathode of the third control element is electrically coupled to the anode of the first surge protection element; and when the first clamping element is a uni-directional device, an anode of the fourth control element is electrically coupled to a fourth pin and a cathode of the fourth control element is electrically coupled to the third pin; and wherein the fifth control element is electrically connected between the third pin and the second surge protection element, and the fifth control element is electrically connected in series with the second surge protection element; and wherein when the first pin is electrically connected with an input and output (I/O) terminal and the fourth pin is electrically connected to a ground terminal, an anode of the fifth control element is electrically coupled to the third pin, a cathode of the fifth control element is electrically coupled to an anode of the second surge protection element, and a cathode of the second surge protection element is electrically coupled to the fourth pin.

28. The transient voltage suppressor circuit with low capacitance according to claim 27, further comprising a plurality of the third control elements which are connected in series, and the plurality of the third control elements are connected in cascade between the first end of the first clamping element and the anode of the first surge protection element.

29. The transient voltage suppressor circuit with low capacitance according to claim 27, further comprising a plurality of the fifth control elements which are connected in series, and the plurality of the fifth control elements are connected in cascade between the second end of the first clamping element and the anode of the second surge protection element.

30. The transient voltage suppressor circuit with low capacitance according to claim 27, wherein each of the first surge protection element and the second surge protection element is a uni-directional device having a snapback property.

31. The transient voltage suppressor circuit with low capacitance according to claim 27, wherein each of the first surge protection element and the second surge protection element is selected from a group consisting of a bipolar junction transistor (BJT) and a silicon controlled rectifier (SCR).

32. The transient voltage suppressor circuit with low capacitance according to claim 27, wherein the first control element, the third control element, the fourth control element and the fifth control element are alternatively selected from a group consisting of a diode, a bipolar junction transistor (BJT) and a silicon controlled rectifier (SCR).

33. The transient voltage suppressor circuit with low capacitance according to claim 1, further comprising: a third control element and a second clamping element, wherein the second clamping element has a third end coupled to the first pin and a fourth end coupled to a fourth pin; and wherein the third control element is electrically connected between the second pin and the first surge protection element, and the third control element is electrically connected in series with the first surge protection element, and an anode of the third control element is electrically coupled to the second pin and a cathode of the third control element is electrically coupled to the anode of the first surge protection element; and wherein when the first clamping element and the second clamping element are uni-directional devices, the fourth pin is electrically connected with an input and output (I/O) terminal and the third pin is electrically connected to a ground terminal, the first end of the first clamping element is a cathode, the second end of the first clamping element is an anode, the third end of the second clamping element is an anode and the fourth end of the second clamping element is a cathode.

34. The transient voltage suppressor circuit with low capacitance according to claim 33, wherein the first clamping element and the second clamping element are selected from a group consisting of a Zener diode, a bipolar junction transistor (BJT), a metal oxide semiconductor field effect transistor (MOSFET), and a silicon controlled rectifier (SCR).

35. The transient voltage suppressor circuit with low capacitance according to claim 33, wherein the first control element and the third control element are alternatively selected from a group consisting of a diode, a bipolar junction transistor (BJT) and a silicon controlled rectifier (SCR).

36. The transient voltage suppressor circuit with low capacitance according to claim 33, further comprising a plurality of the third control elements which are connected in series, and the plurality of the third control elements are connected in cascade between the first end of the first clamping element and the anode of the first surge protection element.

37. The transient voltage suppressor circuit with low capacitance according to claim 21, wherein the first clamping element is alternatively a bi-directional device.

38. The transient voltage suppressor circuit with low capacitance according to claim 24, wherein the first clamping element is alternatively a bi-directional device.

39. The transient voltage suppressor circuit with low capacitance according to claim 27, wherein the first clamping element is alternatively a bi-directional device.

40. The transient voltage suppressor circuit with low capacitance according to claim 33, wherein the first clamping element and the second clamping elements are alternatively bi-directional devices.
